(19) United States
(12) Patent Application Publication
(10) Pub. No.: US 2004/0084139 A1
(43) Pub. Date: May 6, 2004

(54) Apparatus for and method of applying a film to a substrate using electromagnetically induced radiation

(76) Inventor: Roland Boss, Las Canadas Guadalajara (MX)

Correspondence Address: HEWLETT-PACKARD COMPANY, Intellectual Property Administration, P.O. Box 272400, Fort Collins, CO, 80527-2400, US

(21) Appl. No.: 10/284,711

(22) Filed: Oct. 31, 2002

(51) Int. Cl. B32B 31/00

(52) U.S. Cl. 156/272.4; 156/380.2

(57) ABSTRACT

Disclosed is an applicator for bonding a coating portion of a film to a substrate, the film including one or more heat activated layers, the applicator comprising a pair of opposing rollers configured to form a nip region therebetween for engaging the film and the substrate, and a source of extended radio frequency electromagnetic radiation directed at the film in a vicinity of the nip region of the pair of rollers engaging the firm and configured to heat the one or ore heat activated layers thereat to a predetermined temperature.

### FIELD OF THE INVENTION

The present invention is directed generally to applying a film to a substrate and, more particularly, to activating an adhesive layer of a film using electromagnetic radiation.

### DESCRIPTION OF RELATED ART

The present invention is directed generally to applying a film to a substrate and, more particularly, to activating an adhesive layer of a film using electromagnetic radiation.

In electrophotographic printing devices, toner particles are used to form the desired image on the print medium, which is usually some type of paper. Once the toner is applied to the paper, the paper is advanced along the paper path to a fuser. In many printers, copiers and other electrophotographic printing devices, the fuser includes a heated fusing roller engaged by a mating pressure roller. As the paper passes between the rollers, toner is fused to the paper through a process of heat and pressure. A variety of different techniques have been developed to heat the fusing roller. One of the most common techniques for heating a fusing roller uses a quartz lamp placed inside the roller. The lamp is turned on to heat the fusing roller during printing. In this configuration, the roller is typically made of a central core of a material having a high level of heat conductivity, such as aluminum or similar metal or alloy. The central core may be covered by an elastic or rubber coating to facilitate fusing of the plastic ink media (i.e., toner) onto a paper or other web-like printing substrates. Heat generated by the lamp must heat the entirety of the roller prior to operation of the device. Since the roller constitutes a significant thermal mass, it requires substantial time and energy to raise the temperature of the roller to an acceptable operating range.

So called “instant-on” fusers were developed to reduce warm-up time, eliminate the need for standby power and improve print quality in single page or small print jobs. U.S. Pat. Nos. 5,659,867 ('867), 5,087,946 ('946), and 4,724,303 ('303) describe instant-on type fuser heaters that utilize a thin walled heated fusing roller. In the '867 patent, the heating element is a group of resistive conductors positioned on the surface of a thin walled ceramic tube. The conductors are overlaid with a glassy coating to provide a smooth exterior surface for the ceramic tube. In the '946 patent, the heating element is a conductive fiber filler material added to the plastic composition that forms the wall of the roller. In the '303 patent, the heating element is a resistance heating foil or printed circuit glued to the inside surface of the thin metal wall of the roller.

In addition to lamps and heated wires, other forms of heating have been described. For example, U.S. Pat. No. 6,195,525 to Maeyama, entitled “Electromagnetic Induction Heating Device And Image Recording Device Using The Same” issued Feb. 27, 2001 describes an electromagnetic induction heating device which heats an object provided with an electromagnetic induction heat generating layer. The device includes (i) a magnetic core made of magnetic material facing the electromagnetic induction heat-generating layer of the object to be heated, and (ii) an exciting coil wound around the magnetic core that generates a fluctuating magnetic field penetrating the electromagnetic induction heat generating layer. A movable core is used to vary the intensity of the fluctuation magnetic field penetrating the electromagnetic induction heat-generating layer.

U.S. Pat. No. 6,072,964 to Abe, et al., entitled “Image Heating Apparatus With Temperature Detecting Means”, issued Jun. 6, 2000 describes an image heating apparatus having a magnetic flux generating unit. The resultant eddy current generated in a movable member produces heat to thermally fix a toner image to a recording medium.

U.S. Pat. No. 6,031,215 to Nanataki, et al., entitled “Image Heating Device Using Induction Heating For Image Heating”, issued Feb. 29, 2000, describes an image-heating device for heating a film utilizing electromagnetic induction. A sliding member is provided between the film and a film supporting member. The film slides relative to the sliding member to improve thermal efficiency while reducing friction between the film and the supporting member.

U.S. Pat. No. 5,819,150 to Hayasaki, et al., entitled “Image Heating Apparatus”, issued Oct. 6, 1998 describes an image heating apparatus having a conductive layer and a magnetic field generating apparatus for generating a magnetic field. The magnetic field generating apparatus has an exciting coil, electric power being supplied from a power source to the exciting coil by a switching circuit. An eddy current is generated in the heating member by the magnetic field generated by the magnetic field generating apparatus. The heat-generating member generates heat from the eddy current, which is used to fix an image on a recording material.

U.S. Pat. No. 5,745,833 to Abe, et al., entitled “Image Heating Device”, issued Apr. 28, 1998 describes an image-heating device with a movable member having an electroconductive layer adapted to move with a recording member. A magnetizing coil for generating a magnetic flux is provided continuously over the entire width of the movable member in a direction perpendicular to a direction of movement of movable member. A core member guides the magnetic coil such that an eddy current is induced in the movable member, thereby heating an image supported on the recording member by the heat generated in the movable member by the eddy current.

U.S. Pat. No. 5,839,042 to Tomatsu, entitled “Fixing Device in Image Forming Device”, issued Nov. 17, 1998 describes a fixing device having a heat roller and a pressure roller in nipping relation therewith. The heat roller includes a metallic sleeve member and a halogen lamp disposed in a hollow space of the sleeve member. The pressure roller includes a core member and an elastic rubber layer formed over the core member.

U.S. Pat. No. 6,246,035 to Okuda, entitled “Heating Device, Image Forming Apparatus Including the Device and Induction Heating Member Included in the Device”, issued Jun. 12, 2001 describes a heating device suitable for use for fixing a toner image onto a recording medium in, e.g., an electrophotographic image forming apparatus. The heating device includes a heating member, a heat-resistant film having a first surface to be moved relative to and in contact with the heating member and a second surface to be in contact with a member to be heated. The member to be heated and the heat-resistant film are moved together over the heating member to heat the member to be heated.

In addition to printing using toner, similar devices may be used to apply a film or a coating to a substrate, such as paper. Typically, the coating material substance to be applied to the paper is initially applied to a carrier layer. An intermediate release layer may be provided between the coating material and the carrier to provide for subsequent separation of the coating from the carrier layer, while an adhesive layer may be formed on the coating to assist adhesion of the coating to the paper or other receiving media. The coating may be, for example, a thin layer of protective material such as multifunctional acrylate. However, such coating application devices rely on heated rollers to activate an adhesive layer, requiring substantial energy and time to preheat the rollers to an operating temperature.

### BRIEF SUMMARY OF THE INVENTION

An aspect of the invention provides an applicator for bonding a coating portion of a film to a substrate, the film including one or more heat activated layers, the applicator comprising a pair of opposing rollers configured to form a nip region therebetween for engaging the film and the substrate, and a source of extended radio frequency electromagnetic radiation directed at the film in a vicinity of the nip region of the pair of rollers engaging the film, and configured to heat the one or more heat activated layers thereat to a predetermined temperature.

According to another aspect of the invention, a method of bonding coating portion of a film to a substrate comprises radiating the film with an extended radio frequency electromagnetic energy configured to heat at least a portion of the film to a predetermined temperature so as to activate an adhesive layer of the film, and transporting the heated film and the substrate between opposing rollers so as to apply a predetermined pressure sufficient to cause the adhesive layer to adhere to the substrate.

According to another aspect of the invention, an applicator provides for bonding coating portion of a film to a substrate, the film including a heat activated adhesive layer, the applicator comprising means for irradiating the film with an extended radio frequency electromagnetic energy selected to be absorbed by the film and converted to heat energy so as to raise a temperature of at least a portion of the film, and cause an adhesive layer of the film to be activated, and means for applying a pressure to the film and substrate to cause at least a portion of the film to permanently adhere to the substrate.

### BRIEF DESCRIPTION OF THE DRAWINGS

FIG. 1 is a side view of a film applicator mechanism, according to an embodiment of the invention including electromagnetic radiators creating an electromagnetic field inducing heating of the web positioned therebetween; and

FIG. 2 is a side view of a film applicator mechanism, according to an embodiment of the invention including a supply spool providing a continuous web of film and a take-up spool receiving a stripped carrier layer.

### DETAILED DESCRIPTION

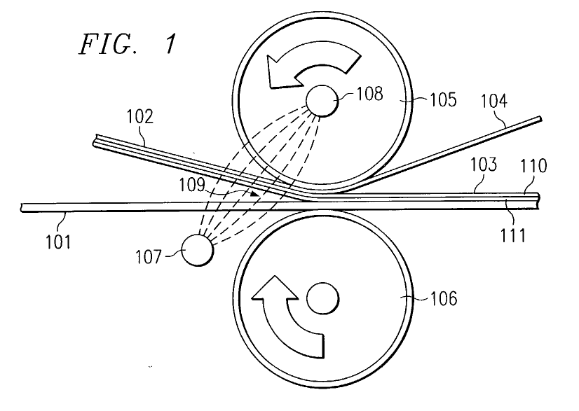

Referring to FIG. 1, an apparatus for applying a coating portion of film 102 to substrate 101 includes an opposing pair of rollers 105 and 106 forming a nip region 109 therebetween. Substrate 101 and film 102 are transported through nip region 109 from left to right as the rollers 105 and 106 rotate in the direction depicted by the arrows. Typically, substrate 101 is paper, while film 102 includes coating layer or layers 103 to be applied to a surface of paper 101. Layers 103 may include a lower adhesive layer (adhesive layer 111), such as may comprise a thermoset resin, and an upper coating or film (coating layer 110), such as may comprise an acrylic resin (preferably which is very thin, such as on the order of microns in thickness). A release layer (not shown), such as may be comprised of a paraffin or other release agent, may be formed between carrier 104, such as may be comprised of a polyethylene film, and coating layers 103 to promote removal of coating layers 103 from carrier 104. In a laser printer or copier environment, roller 105 may be, for example, a fuser type roller while roller 106 may be a pressure roller.

Coating layer 103 may include several layers including, for example, coating layer 110, and heat sensitive adhesive layer 111. As previously mentioned, a release layer (not shown) may be provided between carrier 104 and coating layer 110. Heating of film 102 causes activation of adhesive layer 111 so that coating layer 110 adheres to paper 101 even after carrier film layer 104 is stripped away. For example, radiators 107 and 108 may provide electromagnetic energy sufficient to heat adhesive layer 111 to a temperature in the range of 90 to 140 degrees C., thus facilitating the flow of a thermoset resin therein onto the surface of substrate 101 under pressure applied by rollers 105 and 106. As the thermoset resin of this embodiment of adhesive layer 111 cures, coating layer 110 bonds to substrate 101.

Electromagnetic energy provided by radiators 107 and 108 generates an appropriate electromagnetic field concentrated in the vicinity of nip region 109. The electromagnetic field in the form of, for example, radio frequency waves in an extended radio frequency spectrum from approximately 5 Hz to approximately 300 GHz (referred to herein as extended radio frequency), preferably heats and thereby activates adhesive layer 111 prior to and/or concurrently with pressure being applied by rollers 105 and 106. Heating may further assist in the release of coating layer 110 from carrier 104. One, or both, radiators 107 and 108 can be stand alone or one (or both) could be integral with roller 105 and/or roller 106.

Radiators 107 and 108 are preferably configured to concentrate and direct electromagnetic energy toward nip region 109. The arrangement may include, for example, proper phasing of radio frequency (or other) signals provided to radiators 107 and 108 so as to direct electromagnetic emissions therefrom toward nip region 109. Preferably, the electromagnetic emissions may be in the frequency range of 2 to 3 GHz, and more preferably at or around 2.45 GHz. As one skilled in the art would appreciate, the actual frequency and power used is dependent on the nature, and characteristics of the adhesive and physical configuration of the system, such that it is sufficient to activate the adhesive, and release the carrier while minimizing thermal impact on exposed components. The electromagnetic energy is advantageously absorbed by adhesive layer 111 and converted to heat to activate adhesive properties of the layer. Accordingly, the attributes of the electromagnetic emissions, e.g. the power of the radiated energy, the frequency of the radiated energy, and/or the radiation pattern of the radiated energy, and attributes of the adhesive to be activated, e.g., the activation temperature, the cure time, and/or the electromagnetic absorption properties, are preferably selected to result in a predetermined temperature being reached with respect to the adhesive layer as the material passes through the nip region.

Heating of adhesive layer 111 may be generated by various effects, including inducing vibration or rotation of activated molecules or components of adhesive layer 111 such that heating raises the temperature of adhesive layer 111 to activate it. Thus, adhesive layer 111 may include bipolar or multipolar elements with asymmetric surface charge distribution as part of the adhesive that can be excited in an electromagnetic field between radiators 107 and 108. Alternatively, such bipolar or multipolar components may be microencapsulated and embedded in the adhesive material. In this case, as the bipolar or multipolar components pass through the electromagnetic energy field depicted by the dotted lines in FIG. 1, they are caused to vibrate or rotate in accordance with characteristics of the field (e.g., strength, resonance frequency, etc.) and their chemical binding forces. These motions of the molecules heat up the surrounding ambient (the glue, if the bipolar or multipolar components are not otherwise part of the glue itself) at an extremely high rate, much akin to the way bipolar water molecules are heated in microwave devices.

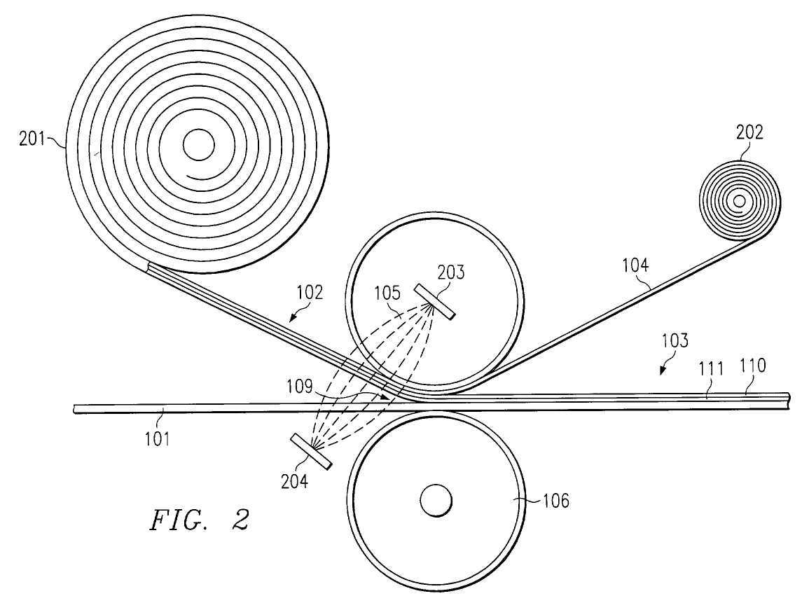

Although radiators 107 and 108 are depicted in cross section as tubular elements such as radiating elements of an antenna, other radiation configurations may be used instead of, or in addition to, the radiator configuration shown. For example, a waveguide comprising a microwave emitter may be used to produce electromagnetic energy substantially as in a conventional microwave oven. Similarly, radiators 203, 204 may form capacitor plates, as shown in FIG. 2, operable to create an electromagnetic field therebetween. Moreover, combinations of various forms of electromagnetic radiators may be used according to the present invention. Accordingly, it should be appreciated that there is no limitation to use the particular radiators illustrated, nor is the invention limited to the configurations shown. For example, a single radiator element may be used where such a configuration may be relied upon to provide a suitable electromagnetic field in nip region 109 for heating of material therein.

FIG. 2 shows supply spindle or roller 201 for supplying film 102 including layers 110 and 111 to be applied to paper 101. Also included is a take up spindle or roller 202 for collecting carrier layer 104 after it has been stripped away from adhesive layer 111 and coating layer 110. In this configuration an electromagnetic field is preferably created between upper capacitor plate 203 and lower capacitor plate 204 by applying an appropriate alternating current signal to the plates. Again, the frequency of the signal is preferably selected to promote heating of adhesive layer 111 and the release of coating layer 110 from carrier layer 104. As discussed, a separate release layer may be included between (or as part of) coating layer 110 and carrier layer 104.

Although heating may be accomplished using radio frequency radiation of a wavelength selected to induce rotation and/or vibratory motion of molecules comprising the adhesive or surrounding ambient to induce heating, other types of electromagnetic radiation may be employed. For example, electromagnetic radiator 107 may comprise a coil of wire with a suitable core material such as a feromagnetic metal (e.g., iron, nickel, cobalt compounds, etc.) while radiator 108 might be a similar structure, but energized with a polarity such that a maximum magnetic field is formed between the two poles created by suitable application of a fluctuating or alternating current. In this case, an alternating magnetic field in the frequency range of 10 to 500 Hz might be provided between radiators 107 and 108. Such an arrangement may be used, for example, when the adhesive layer or other substance to be heated is conductive so as to create eddy current heating of the adhesive.

It should be noted and understood that all publications, patents and patent applications mentioned in this specification are indicative of the level of skill of those skilled in the art to which the invention pertains and is not intended to be an exhaustive listing. All publications, patents and patent applications are herein incorporated by reference to the same extent as if each individual publication patent or patent application was specifically and individually indicated to be incorporated by reference in its entirety.

What is claimed is:

1. An applicator for bonding a coating portion of a film to a substrate, the film including one or more heat activated layers, the applicator comprising:
a pair of opposing rollers configured to form a nip region therebetween for engaging the film and the substrate; and
a source of extended radio frequency electromagnetic radiation directed at the film in a vicinity of said nip region of said pair of rollers engaging the film and configured to heat the one or more heat activated layers thereat to a predetermined temperature.

2. The applicator according to claim 1 wherein said electromagnetic radiation source is integral with at least one of said rollers, and wherein said pair of opposing rollers are rotated to transport the film and substrate therebetween while applying a predetermined pressure to the film and substrate.

3. The applicator according to claim 1 wherein the film comprises at least three layers including a carrier layer, the coating portion, and the heat activated layer, the applicator further comprising a mechanism for stripping the carrier layer away from the coating portion.

4. The applicator according to claim 1 wherein the heat activated layer includes a substance configured to absorb said electromagnetic radiation and convert the absorbed electromagnetic radiation into thermal energy required to activate an adhesive thereby bonding the coating portion to the substrate under pressure applied by said pair of opposing rollers.

5. The applicator according to claim 4 wherein said source of electromagnetic radiation emits electromagnetic radiation of a predetermined extended radio frequency selected to optimally activate the heat activated layer.

6. The applicator according to claim 4 wherein said source of electromagnetic radiation emits electromagnetic radiation of a frequency of between 5 Hz and 300 GHz.

7. The applicator according to claim 1 wherein said source of electromagnetic radiation is operational to activate an adhesive layer of said film.

8. The applicator according to claim 1 wherein said source of electromagnetic radiation is operational to activate a separation layer of said film.

9. The applicator according to claim 1 wherein said heat activated layer comprises an electromagnetic induction heat generating layer.

10. The applicator according to claim 9 wherein said source of electromagnetic radiation comprises an antenna configured to concentrate a fluctuating electromagnetic field in said electromagnetic induction heat generating layer.

11. The applicator according to claim 1 wherein said source of electromagnetic radiation comprises a pair of opposing capacitor plates configured to concentrate a fluctuating electromagnetic field in said film in a vicinity of said nip region.

12. The applicator according to claim 1 wherein the adhesive layer includes a ferromagnetic material configured to absorb said electromagnetic radiation and convert the absorbed electromagnetic radiation into thermal energy required to activate an adhesive thereby bonding the film to the substrate under pressure applied by said pair of opposing rollers.

13. The applicator according to claim 1 wherein said heat activated layer includes ferromagnetic particles and said source of electromagnetic radiation induces an alternating magnetic field selected to be absorbed by said ferromagnetic particles embedded in said heat activated layer to cause heating and activation of the heat activated layer and wherein said alternating magnetic field has a frequency in the range of 5 Hz-00 GHz.

14. The applicator according to claim 1 further comprising a mechanism configured to supply the film in the form of a continuous web comprising a carrier layer, a coating layer and the heat activated layer.

15. The applicator according to claim 14 further comprising a take-up spool configured to strip away and collect said carrier layer after said coating layer is adhered to said substrate.

16. The applicator according to claim 1 wherein the heat activated layer includes components having an asymmetric electrical potential providing a dipolar magnetic environment.

17. The applicator according to claim 1 wherein the heat activated layer includes a plurality of microencapsulated additives responsive to said electromagnetic radiation for heating an adhesive to said predetermined temperature.

18. A method of bonding a coating portion of a film to a substrate comprising:
radiating the film with extended radio frequency electromagnetic energy configured to heat at least a portion of the film to a predetermined temperature so as to activate an adhesive layer of the film; and
transporting the heated film and the substrate between opposing rollers so as to apply a predetermined pressure sufficient to cause the adhesive layer to adhere to the substrate.

19. The method according to claim 18 further comprising a step of stripping away a carrier layer of said film after said transporting step.

20. An applicator for bonding a coating portion of a film to a substrate, the film including a heat activated adhesive layer, the applicator comprising:
means for irradiating the film with extended radio frequency electromagnetic energy selected to be absorbed by the film and converted to heat energy so as to raise a temperature of at least a portion of the film and cause an adhesive layer of the film to be activated; and
means for applying a pressure to the film and substrate to cause at least a portion of the film to adhere to the substrate.
